(19) United States
(12) Patent Application Publication
(10) Pub. No.: US 2025/0254771 A1
(43) Pub. Date: Aug. 7, 2025

(54) LIGHT-EMITTING DIODE DRIVER WITH DYNAMIC FEEDBACK

(71) Applicant: TEXAS INSTRUMENTS INCORPORATED, Dallas, TX (US)

(72) Inventors: Yang WU, Wuhan (CN); Xiaoxiao XU, Hangzhou (CN); Chih Pu YEH, Shanghai (CN)

(21) Appl. No.: 18/433,750

(22) Filed: Feb. 6, 2024

(51) Int. Cl. H05B 45/48; H05B 45/14; H05B 45/37

(52) U.S. Cl. CPC H05B 45/48; H05B 45/14; H05B 45/37

(57) ABSTRACT

A light-emitting diode (LED) driver includes: current regulation circuitry; feedback control circuitry coupled to the current regulation circuitry; and a set of terminals coupled to the current regulation circuitry and adapted to be coupled to respective LED strings. The current regulation circuitry is configured to selectively provide current to each of the LED strings. The feedback control circuitry is configured to: monitor a voltage level for each of the LED strings while current is being provided; and provide feedback results responsive to the monitored voltage levels.

### BACKGROUND

Light-emitting diode (LED) drivers conventionally use fixed voltages to drive red, green, and blue LEDs. Although the use of fixed voltages by an LED driver is simple, the related power consumption is not optimal.

### SUMMARY

In an example, a light-emitting diode (LED) driver includes: current regulation circuitry; feedback control circuitry coupled to the current regulation circuitry; and a set of terminals coupled to the current regulation circuitry and adapted to be coupled to respective LED strings. The current regulation circuitry is configured to selectively provide current to each of the LED strings. The feedback control circuitry is configured to: monitor a voltage level for each of the LED strings while current is being provided; and provide feedback results responsive to the monitored voltage levels.

In another example, a circuit includes: a controller having a first terminal and a second terminal; and a LED driver having a first terminal, a second terminal, and output terminals. The first terminal of the LED driver is coupled to first terminal of the controller. The second terminal of the LED driver is coupled to the second terminal of the controller. The output terminals are adapted to be coupled to respective LED strings. The controller is configured to: provide a LED control voltage at the first terminal of the controller; receive feedback results at the second terminal of the controller; and selectively adjust the LED control voltage provided to the first terminal of the controller responsive to the feedback results. The LED driver is configured to: receive the LED control voltage at the first terminal of the LED driver; selectively provide a current to each of the LED strings, the current for at least some of the LED strings based on the LED control voltage; monitor a voltage level for each of the LED strings while current is being provided; and provide the feedback results at the second terminal of the LED driver responsive to the monitored voltage levels.

In yet another example, a display includes: a controller; LED drivers coupled to the controller; and LED strings coupled to each of the LED drivers. The controller is configured to: receive feedback results from the LED drivers; and dynamically adjust LED control voltages provided to the LED drivers responsive to the feedback results.

### BRIEF DESCRIPTION OF THE DRAWINGS

FIG. 1 is a block diagram showing example display circuitry.

FIG. 2A is a graph showing forward current as a function of forward voltage of a light-emitting diode (LED), in an example.

FIG. 2B is a graph showing relative forward voltage as a function of junction temperature of an LED, in an example.

FIG. 3 is a graph showing output current and LED voltage minus channel voltage for different channel currents, in an example.

FIG. 4 is a diagram showing other example display circuitry.

FIG. 5 is a diagram showing another feedback control circuitry of an LED driver, in an example.

FIG. 6 is a block diagram showing other example display circuitry.

FIG. 7 is a diagram showing other example display circuitry.

FIG. 8 is a diagram showing other example display circuitry.

FIGS. 9-11 are diagrams showing example systems.

FIG. 12 is a flowchart showing an example LED driver control method.

### DETAILED DESCRIPTION

The same reference numbers or other reference designators are used in the drawings to designate the same or similar features. Such features may be the same or similar either by function and/or structure.

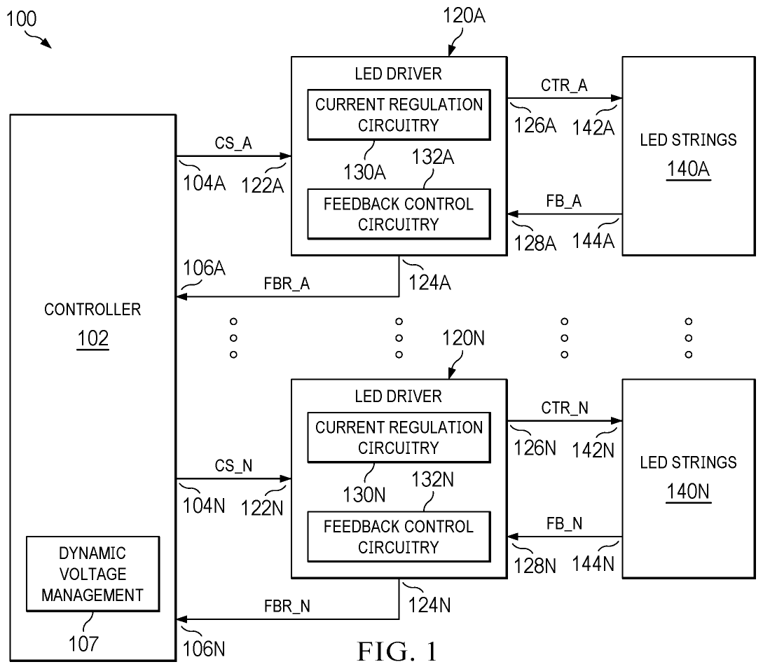

Described herein are light-emitting diode (LED) drivers that include feedback control circuitry and related dynamic power management options for displays and related systems. FIG. 1 is a block diagram showing example display circuitry 100. As shown, the display circuitry 100 includes a controller 102, LED drivers 120A to 120N, and LED strings 140A to 140N. In the example of FIG. 1, the controller 102 includes dynamic voltage management circuitry 107. Also, each of the LED drivers 120A to 120N includes respective current regulation circuitry 130A to 130N and respective feedback control circuitry 132A to 132N.

The controller 102 has a set of first terminals 104A to 104N and a second of second terminals 106A to 106N. Each of the LED drivers 120A to 120N has a respective first terminal 122A to 122N, a respective second terminal 124A to 124N, a respective third terminal 126A to 126N, and a respective fourth terminal 128A to 128N. Each of the LED strings 140A to 140N has a respective first terminal of the first terminal 142A to 142N and a respective second terminal of the second terminal 144A to 144N.

Each first terminal of the set of first terminals 104A to 104N of the controller 102 is coupled to a respective first terminal of the first terminals 122A to 122N of the LED drivers 120A to 120N. Each second terminal of the set of second terminals 106A to 106N of the controller 102 is coupled to a respective second terminal of the second terminals 124A to 124N of the LED drivers 120A to 120N. Each third terminal of the third terminals 126A to 126N of the LED drivers 120A to 120N is coupled to a respective first terminal of the first terminals 142A to 142N of the LED strings 140A to 140N. Each fourth terminal of the fourth terminals 128A to 128N of the LED drivers 120A to 120N is coupled to a respective second terminal of the second terminals 144A to 144N of the LED strings 140A to 140N.

In some examples, the controller 102 operates to: provide control signals (e.g., CS_A to CS_N) at the set of first terminals 104A to 104N responsive to a default configuration; receive feedback result signals (e.g., FBR_A to FBR_N) from the LED drivers 120A to 120N at the set of second terminals 106A responsive to the provided control signals; and provide updated control signals (e.g., updated versions of CS_A to CS_N) as needed at the set of first terminals 104A to 104N responsive to the received feedback result signals. In some examples, the dynamic voltage management circuitry 107 of the controller 102 operates to: receive the feedback result signals (e.g., FBR_A to FBR_N); and adjust control voltages for each the LED drivers 120A to 120N, individually or together, responsive to the feedback result signals. In some examples, CS_A to CS_N at respective terminals of the set of first terminals 104A to 104N include the control voltages adjusted by the dynamic voltage management circuitry 107. Without limitation, the control voltages may include a first control voltage to power red LEDs and a second control voltage to power green and blue LEDs.

In some examples, each of the LED drivers 120A to 120N operates to: receive a respective control signal (e.g., CS_A to CS_N) at a respective first terminal 122A to 122N; perform respective current regulation operations responsive to a respective control signal using respective current regulation circuitry of the current regulation circuitry 130A to 130N; and provide respective regulated current (e.g., CTR_A to CTR_N) at a respective terminal of the third terminals 126A to 126N.

In some examples, each of the LED drivers 120A to 120N also operates to receive a feedback signal (e.g., FB_A to FB_N) from a respective LED string of the LED strings 140A to 140N. For example, each respective feedback signal may be received at a respective terminal of the fourth terminals 128A to 128N of the LED drivers 120A to 120N. In some examples, each of the LED drivers 120A to 120N also operates to: generate a respective feedback result signal (e.g., FBR_A to FBR_N) responsive to a respective feedback signal and target settings managed by each respective feedback control circuitry of the feedback control circuitry 132A to 132N; and provide a respective feedback result signal to a respective terminal of the second terminals 124A to 124N.

In some examples, each respective LED string of the LED strings 140A to 140N operates to: receive a respective control signal (e.g., CTR_A to CTR_N) at a respective terminal of the first terminals 142A to 142N; operate respective LEDs responsive to the respective control signal; and provide a feedback signal (e.g., FB_A to FB_N) at a respective terminal of the second terminals 144A to 144N responsive to operations of the respective LEDs.

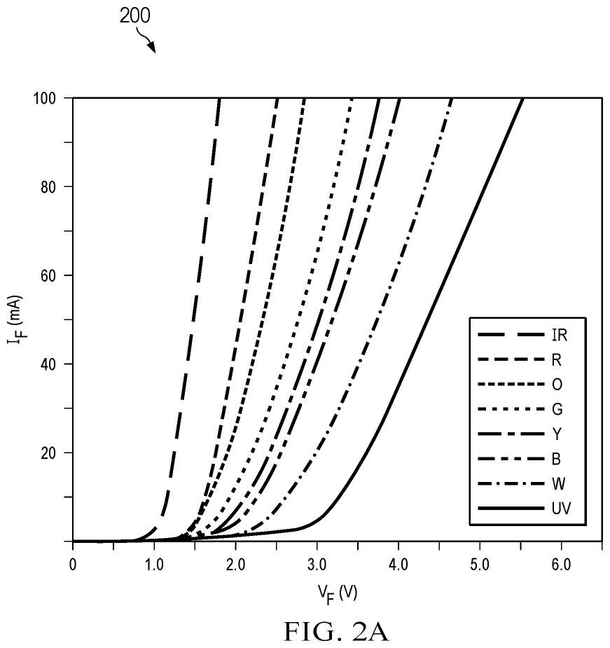

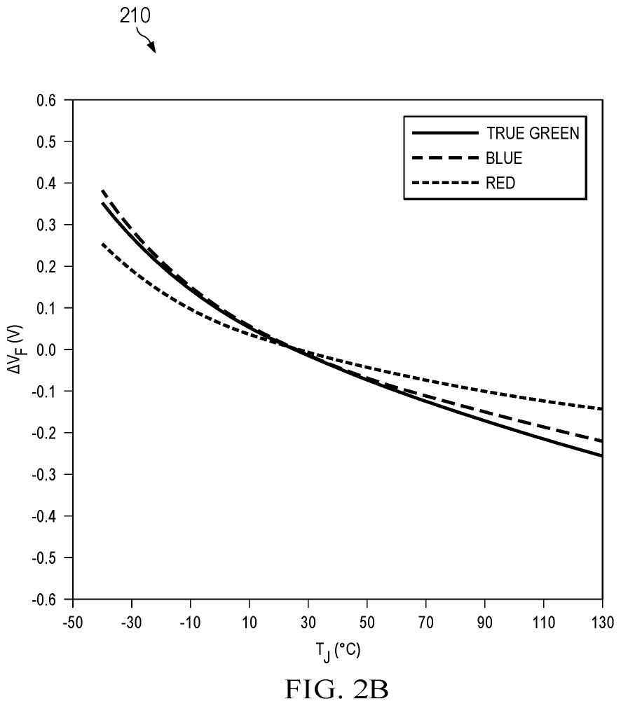

FIG. 2A is a graph 200 showing forward current (I_{F}) as a function of forward voltage (V_{F}) of an LED. In graph 200, I_{F} and V_{F} are represented for different colors including: infrared (IR), red (R), orange (O), green (G), yellow (Y), blue (B), white (W), and ultraviolet (UV). As shown, V_{F} increases as I_{F} increases for all the colors and varies for each color.

FIG. 2B is a graph 210 showing relative forward voltage (ΔV_{F}) as a function of junction temperature (T_{J}) of an LED. In graph 210, the relative forward voltage for true green, blue, and red LEDs decreases as junction temperature increases. As shown, initial forward voltage values (when temperature is around −40° C.) and the rate of decrease for true green, blue, and red LEDs varies. Because the forward voltage of different color LEDs varies as a function of forward current (e.g., as in graph 200) and junction temperature (e.g., as in graph 210), a fixed control voltage for all LEDs does not optimize power consumption.

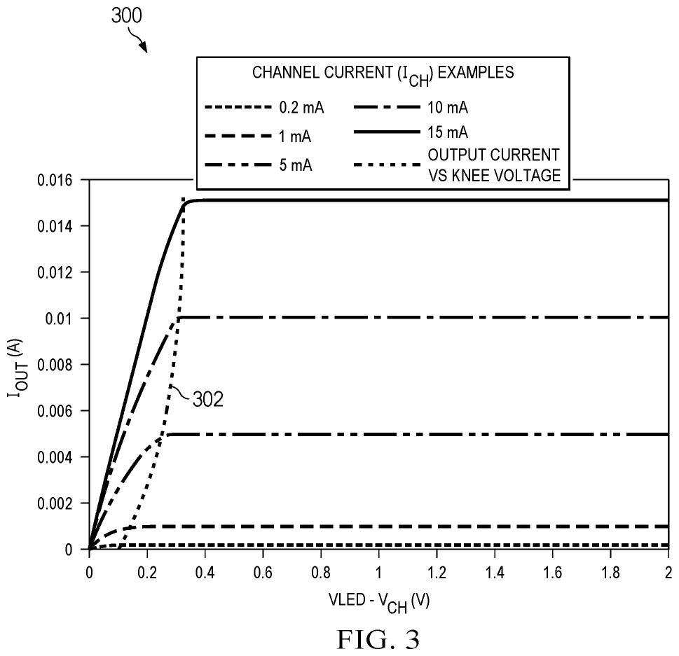

FIG. 3 is a graph 300 showing output current (I_{OUT}) and LED voltage (VLED) minus channel voltage (V_{CH}) for different example channel current (I_{CH}) levels. As used herein, I_{OUT} refers to the output current provided by an LED driver. VLED refers to the control voltage used to generate I_{OUT}. I_{CH} refers to the current provided to an LED string or channel. V_{CH} refers to the voltage provided to an LED string or channel. In some examples, there may be a separate I_{OUT}, VLED, V_{CH}, and I_{CH} for each color supported by an LED driver. Also, when an LED driver is coupled to respective LED strings or channels, each I_{OUT} provided by the LED driver is equal to a respective I_{CH}.

In graph 300, the example I_{CH} levels include 0.2 mA, 1 mA, 5 mA, 10 mA, and 15 mA. For each respective I_{CH} level, I_{OUT} increases as V_{LED}−V_{CH} increases up to a maximum respective I_{OUT} for each example I_{CH} level. The V_{LED}−V_{CH} value at which I_{OUT} does not increase more for a given I_{CH} level is referred to herein as a “knee voltage”. In graph 300, curve 302 shows that knee voltage values vary for the example I_{CH} levels. More specifically, as the I_{CH} level increases, the knee voltage increases. One option to reduce power consumption of LEDs involves replacing fixed control voltages for LED strings (e.g., the LED strings 140A to 140N in FIG. 1) with dynamic adjustment of control voltages for LED strings responsive to monitored parameters (e.g., I_{CH}) and configuration options (e.g., different brightness options such as day mode, night mode, etc.). The dynamic adjustment of control voltages may account for changes in the forward voltage of LEDs and a function of temperature and/or changes in the forward voltage of LEDs as a function of forward current and LED color.

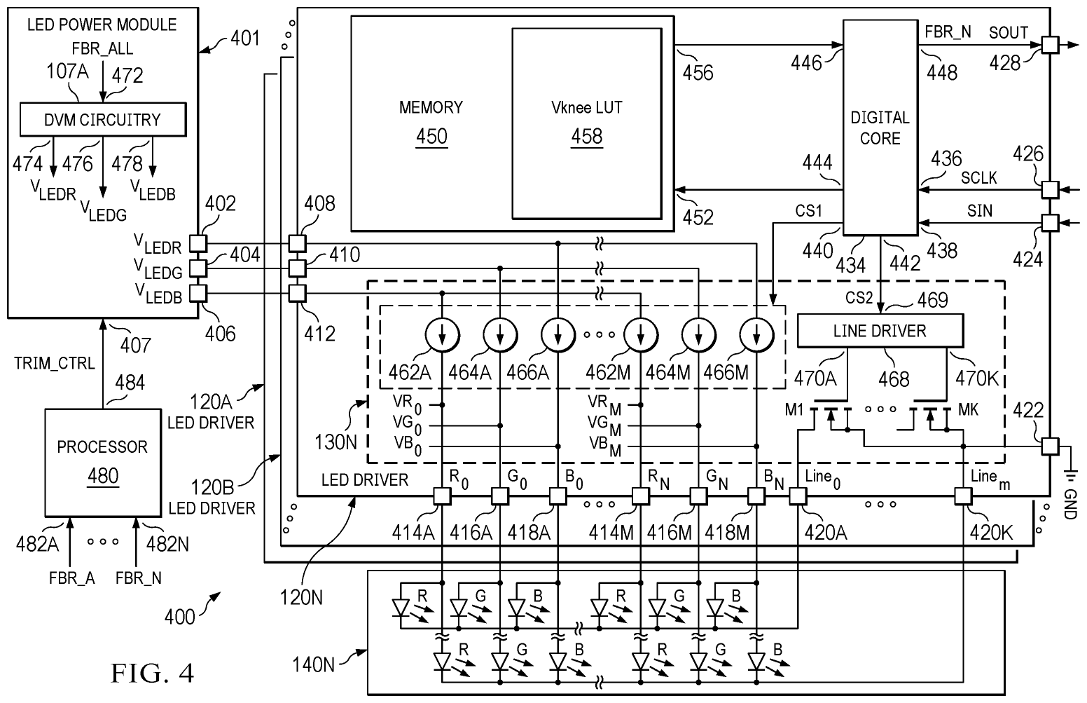

FIG. 4 is a diagram showing other example display circuitry 400. The display circuitry 400 includes an LED power module 401, a processor 480, the LED drivers 120A to 120N, and the LED string 140N. In the example of FIG. 4, the LED power module 401 and the processor 480 are example components of the controller 102 in FIG. 1. Although only the LED strings 140N is represented in FIG. 4, each of the LED drivers 120A to 120M may control respective LED strings (e.g., one of the LED strings 140A to 140M in FIG. 1).

In the example of FIG. 4, the LED power module 401 has a first terminal 402, a second terminal 404, a third terminal 406, and a fourth terminal 407. The processor 480 has a set of first terminals 482A to 482N and a second terminal 484. The LED power module 401 includes dynamic voltage management (DVM) circuitry 107A. The dynamic voltage management circuitry 107A is an example of the dynamic voltage management circuitry 107 in FIG. 1. In the example of FIG. 4, the dynamic voltage management circuitry 107A has a first terminal 472, a second terminal 474, a third terminal 476, and a fourth terminal 478.

The LED driver 120N has a first terminal 408, a second terminal 410, a third terminal 412, a set of fourth terminals 414A to 414M, a set of fifth terminals 416A to 416M, a set of sixth terminals 418A to 418M, a set of seventh terminals 420A to 420K, an eighth terminal 422, a ninth terminal 424, a tenth terminal 426, and an eleventh terminal 428.

The LED driver 120N includes the current regulation circuitry 130N, a digital core 434, and memory 450. In some examples, the digital core 434 and the memory 450 are components of the feedback control circuitry 132N in FIG. 1. In some examples, the current regulation circuitry 130N includes a first set of current sources 462A to 462M, a second set of current sources 464A to 464N, a third set of current source 466A to 466M input terminals, line driver circuitry 468, and transistors M1 to MK. Each of the transistors M1 to MK has a respective first terminal, a respective second terminal, and a respective control terminal. The line driver circuitry 468 has a first terminal 469 and a set of second terminals 470A to 470K. The digital core 434 has a first terminal 436, a second terminal 438, a third terminal 440, a fourth terminal 442, a fifth terminal 444, a sixth terminal 446, and a seventh terminal 448. The memory 450 has a first terminal 452 and a second terminal 456. In the example of FIG. 4, the memory 450 includes a knee voltage (Vknee) look-up table (LUT) 458. Table 1 shows an example Vknee LUT.

TABLE 1

| I_{OUT} - Output Current (mA) | Vknee - Knee Voltage (V) |
|---|---|
| 0.1 | Vknee@0.1 |
| 0.2 | Vknee@0.2 |
| . . . | . . . |
| Imax | Vknee@Imax |

In the example of Table 1, different I_{OUT} levels and related Vknee levels are stored. In some examples, the I_{OUT} level for each LED string of an LED driver may be calculated based on a global brightness level, individual color brightness levels, and/or user configuration options. The I_{OUT} levels are used as an index to look-up related Vknee levels in the Vknee LUT. In some examples, Vknee levels are used to determine feedback results.

In the example of FIG. 4, each current source of the first set of current sources 462A to 462M, the second set of current sources 464A to 464N, the third set of current source 466A has an input terminal and an output terminal. Each input terminal of each current source of the first set of current sources 462A to 462M is coupled to the third terminal 412. Each input terminal of each current source of the second set of current sources 464A to 464M is coupled to the second terminal 410. Each input terminal of each current source of the third set of current sources 466A to 466M is coupled to the first terminal 408. Each output terminal of each current source of the first set of current sources 462A to 462M is coupled to a respective terminal of the set of fourth terminals 414A to 414M. Each output terminal of each current source of the second set of current sources 464A to 464M is coupled to a respective terminal of the set of fifth terminals 416A to 416M. Each output terminal of each current source of the third set of current sources 466A to 466M is coupled to a respective terminal of the set of sixth terminals 418A to 418M.

In the example of FIG. 4, the LED strings 140N include: channels of red LEDs with respective anode terminals coupled to respective terminals of the set of fourth terminals 414A to 414M; channels of green LEDs with respective anode terminals coupled to respective terminals of the set of fifth terminals 416A to 416M; and channels of blue LEDs with respective anode terminals coupled to respective terminals of the set of sixth terminals 418A to 418M. In some examples, red LEDs, green LEDs, and blue LEDs of the LED strings 140N are organized as rows, where each row of red LEDs, green LEDs, and blue LEDs has its cathode terminals coupled to a respective terminal of the set of seventh terminals 420A to 420K.

In some examples, the respective terminals of the set of seventh terminals 420A to 420K are coupled to respective first terminals of the transistors M1 to MK. The respective second terminals of the transistors M1 to MK are coupled to the eighth terminal 422. In the example of FIG. 4, the eighth terminal 422 is coupled to ground or a ground terminal. The control terminals of the transistors M1 to MK are coupled to respective terminals of the set of second terminals 470A to 470K of the line driver circuitry 468. The first terminal 469 of the line driver circuitry 468 is coupled to the fourth terminal 442 of the digital core 434. The first terminal 436 of the digital core 434 is coupled to the tenth terminal 426 of the LED driver 120N. The second terminal 438 of the digital core 434 is coupled to the ninth terminal 424 of the LED driver 120. The third terminal 440 of the digital core 434 is coupled to control terminals of the first set of current sources 462A to 462M, control terminals of the second set of current sources 464A to 464M, and control terminals of the third set of current sources 466A to 466M. In some examples, the digital core 434 operates to control the current provided by each current source of the first set of current sources 462A to 462M, the second set of current sources 464A to 464M, and the third set of current sources 466A to 466M. The fifth terminal 444 of the digital core 434 is coupled to the first terminal 452 of the memory 450. The sixth terminal 446 of the digital core 434 is coupled to the second terminal 456 of the memory 450. The seventh terminal 448 of the digital core 434 is coupled to the eleventh terminal 428 of the LED driver 120N.

In the example of FIG. 4, the terminal 482N of the set of first terminals 482A to 482N of the processor 480 is coupled to the eleventh terminal 428 of the LED driver 120N. Also, each of the LED drivers 120A to 120M has a respective terminal (not shown) coupled to a respective terminal of the set of first terminals 482A to 482N of the processor 480 to provide FBR_A to FBR_M. The second terminal 484 of the processor 480 is coupled to the fourth terminal 407 of the LED power module 401. The first terminal 402 of the LED power module 401 is coupled to the first terminal 408 of the LED driver 120N. The second terminal 404 of the LED power module 401 is coupled to the second terminal 410 of the LED driver 120N. The third terminal 406 of the LED power module 401 is coupled to the third terminal 412 of the LED driver 120N.

In some examples, the first terminal 472 of the dynamic voltage management circuitry 107A is coupled to the fourth terminal 407 of the LED power module 401. The second terminal 474 of the dynamic voltage management circuitry 107A is coupled to the first terminal 402 of the LED power module 401. The third terminal 476 of the dynamic voltage management circuitry 107A is coupled to the second terminal 404 of the LED power module 401. The fourth terminal 478 of the dynamic voltage management circuitry 107A is coupled to the third terminal 406 of the LED power module 401.

In some examples, the processor 480 operates to: receive feedback result signals (e.g., FBR_A to FBR_N) at the set of first terminals 482A to 482N; and generate trim control signals (TRIM_CTRL) at the second terminal 484 responsive to the feedback result signals. In some examples, the feedback result signal or cumulative feedback results indicate an increase request, a decrease request, or a maintain request for each of multiple LED control voltages provided by the LED power module 401.

In some examples, the LED power module 401 operates to: receive TRIM_CTRL at the fourth terminal 407; adjust control voltages (e.g., V_{LEDR}, V_{LEDG}, V_{LEDB}) as needed responsive to TRIM_CTRL and operations of the dynamic voltage management circuitry 107A; and provide respective control voltages (adjusted or not adjusted as appropriate) to the first terminal 402, the second terminal 404, and the third terminal 406.

In some examples, the LED driver 120N operates to: receive control voltages (e.g., V_{LEDR}, V_{LEDG}, V_{LEDB}) at the first terminal 408, the second terminal 410, and the third terminal 412; selectively provide currents to the set of fourth terminals 414A to 414M responsive to V_{LEDR}, operations of the digital core 434, operations of the line driver circuitry 468, and operations of the current regulation circuitry 130N (e.g., by control of each of the first set of current sources 462A to 462M); selectively provide currents to the set of fifth terminals 416A to 416M responsive to V_{LEDG}, operations of the digital core 434, operations of the line driver circuitry 468, and operations of the current regulation circuitry 130N (e.g., by control of each of the second set of current sources 464A to 464M); and selectively provide currents to the set of sixth terminals 418A to 418M responsive to V_{LEDB}, operations of the digital core 434, operations of the line driver circuitry 468, and operations of the current regulation circuitry 130N (e.g., by control of each of the third set of current sources 466A to 466M). The LED driver 120N operates to: monitor voltage levels (e.g., VR₀ to VR_{M}) at each of the set of fourth terminals 414A to 414M; monitor voltage levels (e.g., VG₀ to VG_{M}) at each of the set of fifth terminals 416A to 416M; monitor voltage levels (e.g., VB₀ to V_{M}) at each of the set of sixth terminals 418A to 418M; and provide the monitored voltage or related sense signals to the digital core 434.

In some examples, the current regulation circuitry 130A operates to: receive V_{LEDR}, V_{LEDG}, V_{LEDB}, CS1, and CS2; selectively provide current to the set of fourth terminals 414A to 414M responsive to V_{LEDR}, operations of the current sources 462A to 462M responsive to CS1, and operations of the line driver circuitry 468 to control the transistors M1 to MK responsive to CS2; selectively provide current to the set of fifth terminals 416A to 416M responsive to V_{LEDG}, operations of the current sources 464A to 464M responsive to CS1, and operations of the line driver circuitry 468 to control the transistors M1 to MK responsive to CS2; and selectively provide current to the set of sixth terminals 418A to 418M responsive to V_{LEDB}, operations of the current sources 466A to 466M responsive to CS1, and operations of the line driver circuitry 468 to control the transistors M1 to MK responsive to CS2.

In some examples, the feedback control operations of the LED driver 120N are based on input data received at the ninth terminal 424 and an input clock received at the tenth terminal 426. The input data may include Vknee values or LUTs, an output current formula to calculate output current (channel current) based on a global brightness setting and color brightness settings, and/or other input data.

In some examples, the digital core 434 includes a processor or microcontroller (MCU). Example functions of the digital core 434 include, but are not limited to, channel control, frame controller, line control, clock control, memory control, communication control, and dynamic feedback control. In some examples, the digital core 434 operates to: receive the input clock at the first terminal 436; receive input data at the second terminal 438; provide the input data or related values to the memory 450 via the fifth terminal 444; provide a first control signal (CS1) at the third terminal 440 responsive to I_{CH}; provide a second control signal (CS2) at the fourth terminal 442 responsive to LED on/off timing; receive Vknee values and/or other feedback values at the sixth terminal 446 responsive to feedback control operations; determine FBR_N responsive to the Vknee values and feedback result operations; and provide FBR_N at the seventh terminal 448.

In some examples, the memory 450 may be a non-volatile memory, such as random-access memory (RAM) or flash memory. In some examples, the memory 450 operates to: store instructions or data for use by the digital core 434; and store a Vknee LUT for use by the digital core 434. In some examples, the memory 450 operates to: receive output current values determined by the digital core 434 at the first terminal 452; and provide Vknee values at the second terminal 456 responsive to the output current values.

In the example of FIG. 4, each of the LED drivers 120A to 120M may have the same or similar components as the LED driver 120N. Each of the LED drivers 120A to 120M may perform operations similar to those described for the LED driver 120N to provide respective feedback result signals (e.g., FBR_A to FBR_M) to the processor 480. In some examples, the feedback result signals may be partially or wholly combined by the LED drivers 120A to 120N and conveyed to the processor 480 via a communication interface.

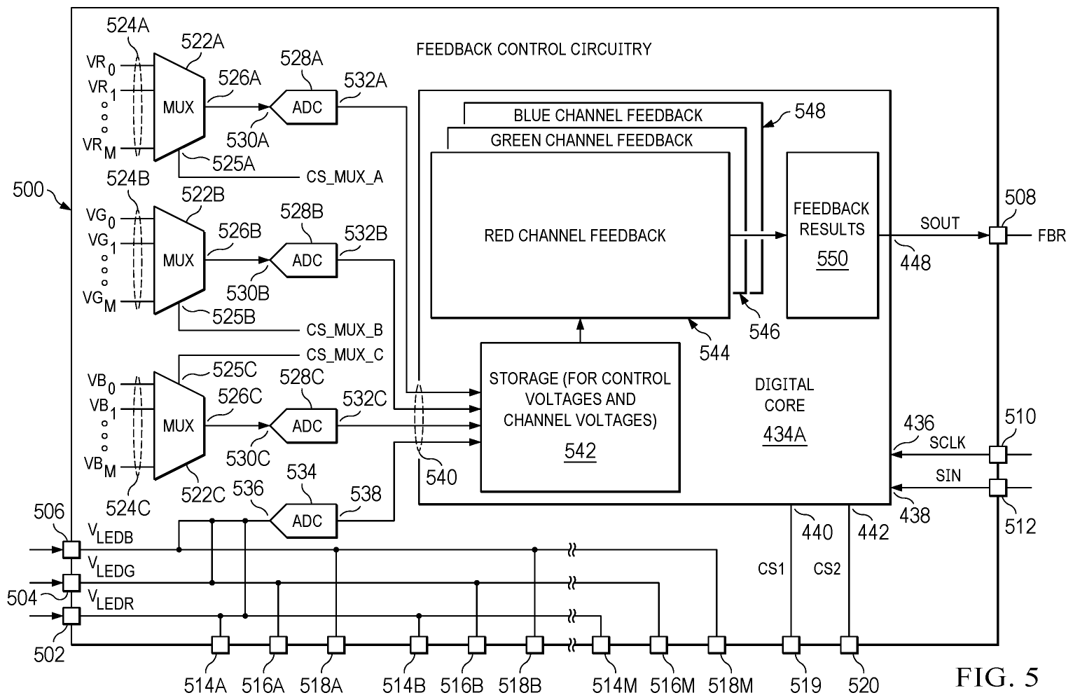

FIG. 5 is a diagram showing example feedback control circuitry 500 of an LED driver. The feedback control circuitry 500 is an example of any one of the feedback control circuitry 132A to 132N described in FIG. 1, or related components (e.g., the digital core 434 and memory 450) in FIG. 2. As shown, the feedback control circuitry 500 has a first terminal 502, a second terminal 504, a third terminal 506, a fourth terminal 508, a fifth terminal 510, a sixth terminal 512, a set of seventh terminals 514A to 514M, a set of eighth terminals 516A to 516M, a set of ninth terminals 518A to 518M, a tenth terminal 519, and an eleventh terminal 520.

In the example of FIG. 5, the feedback control circuitry 500 includes an analog-to-digital converter (ADC) 534, multiplexers 522A to 522C, ADCs 528A to 528C, and a digital core 434A. The digital core 434A is an example of the digital core 434 in FIG. 4. The ADC 534 has a first terminal 536 and a second terminal 538. The multiplexer 522A has a set of first terminals 524A, a second terminal 525A, and a third terminal 526A. The multiplexer 522B has a set of first terminals 524B, a second terminal 525B, and a third terminal 526B. The multiplexer 522C has a set of first terminals 524C, a second terminal 525C, and a third terminal 526C. The ADC 528A has a first terminal 530A and a second terminal 532A. The ADC 528B has a first terminal 530B and a second terminal 532B. The ADC 528C has a first terminal 530C and a second terminal 532C. The digital core 434A has the first terminal 436, the second terminal 438, the third terminal 440, the fourth terminal 442, and the seventh terminal 448 described for the digital core 434 in FIG. 4. The digital core 434A also has a set of terminals 540. In the example of FIG. 5, the digital core 434A includes storage 542, red channel feedback logic 544, green channel feedback logic 546, blue channel feedback logic 548, and feedback results logic 550.

In the example of FIG. 5, the first terminal 502 is coupled to the set of seventh terminals 514A to 514M and to the first terminal 536 of the ADC 534. The second terminal 504 is coupled to the set of eighth terminals 516A to 516M and to the first terminal 536 of the ADC 534. The third terminal 506 is coupled to the set of ninth terminals 518A to 518M and to the first terminal 536 of the ADC 534. In some examples, the ADC 534 is a multi-channel ADC and the first terminal 502, the second terminal 504, and the third terminal 506 are coupled to respective input channels of the ADC 534. The second terminal 538 of the ADC 534 is coupled to a respective terminal of the set of terminals 540.

The set of first terminals 524A of the multiplexer 522A receives red channel voltages (e.g., VR₀ to VR_{M} in FIG. 4). For example, the set of first terminals 524A of the multiplexer 522A may be coupled to the set of fourth terminals 414A to 414M in FIG. 4 to receive the red channel voltages. The second terminal 525A of the multiplexer 522A receives a control signal (CS_MUX_A) from a controller (not shown) to forward respective red channel voltages to the ADC 528A. The third terminal 526A of the multiplexer 522A is coupled to the first terminal 530A of the ADC 528A. The second terminal 532A of the ADC 528A is coupled to a respective terminal of the set of terminals 540.

The set of first terminals 524B of the multiplexer 522B receives green channel voltages (e.g., VG₀ to VG_{M} in FIG. 4). For example, the set of first terminals 524B of the multiplexer 522B may be coupled to the set of fifth terminals 416A to 416M in FIG. 4 to receive green channel voltages. The second terminal 525B of the multiplexer 522B receives a control signal (CS_MUX_G) from a controller (not shown) to forward respective green channel voltages to the ADC 528B. The third terminal 526B of the multiplexer 522B is coupled to the first terminal 530B of the ADC 528B. The second terminal 532B of the ADC 528B is coupled to a respective terminal of the set of terminals 540.

The set of first terminals 524C of the multiplexer 522C receives blue channel voltages (e.g., VB₀ to VB_{M} in FIG. 4). For example, the set of first terminals 524C of the multiplexer 522C may be coupled to the set of sixth terminals 418A to 418M in FIG. 4 to receive blue channel voltages. The second terminal 525C of the multiplexer 522C receives a control signal (CS_MUX_B) from a controller (not shown) to forward respective green channel voltages to the ADC 528C. The third terminal 526C of the multiplexer 522C is coupled to the first terminal 530C of the ADC 528C. The second terminal 532C of the ADC 528C is coupled to a respective terminal of the set of terminals 540.

In the example of FIG. 5, the feedback control circuitry 500 operates to: receive V_{LEDR} at the first terminal 502; receive V_{LEDG} at the second terminal 504; V_{LEDB} at the third terminal 506; receive red channel voltages (e.g., VR₀ to VR_{M}); receive green channel voltages (e.g., VG₀ to VG_{M}); receive blue channel voltages (e.g., VB₀ to VB_{M}); receive an input clock at the fifth terminal 510; receive input data at the sixth terminal 512; and perform feedback control operations responsive to the V_{LEDR}, V_{LEDG}, V_{LEDB}, red channel voltages, green channel voltages, blue channel voltages, the input clock, and the input data.

In the example of FIG. 5, the multiplexer 522A operates to: receive red channel voltages (e.g., VR₀ to VR_{M}) at the set of first terminals 524A; receive CS_MUX_A at the second terminal 525A; and forward a respective red channel voltage to the third terminal 526A responsive to the CS_MUX_A. The multiplexer 522B operates to: receive green channel voltages (e.g., VG₀ to VG_{M}) at the set of first terminals 524B; receive CS_MUX_B at the second terminal 525B; and forward a respective green channel voltage to the third terminal 526B responsive to the CS_MUX_B. The multiplexer 522C operates to: receive blue channel voltages (e.g., VB₀ to VB_{M}) at the set of first terminals 524C; receive CS_MUX_C at the second terminal 525C; and forward a respective red channel voltage to the third terminal 526C responsive to the CS_MUX_C.

The ADC 534 operates to: receive V_{LEDR}, V_{LEDG}, and V_{LEDB} at this first terminal 536; and provide digitized values of V_{LEDR}, V_{LEDG}, and V_{LEDB} at the second terminal 538. The ADC 528A operates to: receive red channel voltages at the first terminal 530A; and provide digitized values of the red channel voltages at the second terminal 532A. The ADC 528B operates to: receive green channel voltages at the first terminal 530B; and provide digitized values of the green channel voltages at the second terminal 532B. The ADC 528C operates to: receive blue channel voltages at the first terminal 530C; and provide digitized values of the blue channel voltages at the second terminal 532C.

The digital core 434A operates to: receive digitized values of V_{LEDR}, V_{LEDG}, V_{LEDB}, red channel voltages, green channel voltages, and blue channel voltages at the set of terminal 540; receive an input clock at the first terminal 436; receive input data at the second terminal 438; provide CS1 at the third terminal 440 responsive to I_{CH}; and provide CS2 at the fourth terminal 442 responsive to LED on/off timing. In some examples, the input data includes a global brightness value, color brightness control values for red, green, and blue. In some examples, red channel currents, green channel currents, and blue channel currents are determined responsive to the global brightness value and respective color brightness control values for red, green, and blue. In some examples, the digital core 434A also operates to look-up or determine Vknee values responsive to the red channel currents, green channel currents, and blue channel currents.

In some examples, the digital core 434A operates to determine feedback results (FBR, for example, FBR_A to FBR_N in FIGS. 1 and 4) responsive to the Vknee values, V_{LEDR}, V_{LEDG}, V_{LEDB}, red channel voltages, green channel voltages, blue channel voltages, and/or other values, operations of the storage 542, operations of the red channel feedback logic 544, operations of the green channel feedback logic 546, operations of the blue channel feedback logic 548, and operations of the feedback results logic 550. The feedback results are provided to the seventh terminal 448.

In some examples, the digital core 434A operates to: determine a maximum red channel voltage (VR_{MAX}) value of the digitized red channel voltages; determine a minimum red channel voltage (VR_{MIN}) value of the digitized red channel voltages; and store VR_{MAX} and VR_{MIN} in the storage 542. The digital core 434A also operates to: determine a maximum green channel voltage (VG_{MAX}) value of the digitized green channel voltages; determine a minimum green channel voltage (VG_{MIN}) value of the digitized green channel voltages; and store VG_{MAX} and VG_{MIN} in the storage 542. The digital core 434A also operates to: determine a maximum blue channel voltage (VB_{MAX}) value of the digitized blue channel voltages; determine a minimum blue channel voltage (VB_{MIN}) value of the digitized blue channel voltages; and store VB_{MAX} and VB_{MIN} in the storage 542. The digital core 434A also operates to store digitized values of V_{LEDR}, V_{LEDG}, V_{LEDB} in the storage.

In some examples, the red channel feedback logic 544 operates to: receive VR_{MAX}, VR_{MIN}, Vknee for a predetermined red channel current (i.e., Vknee@Ich_R); and determine feedback results responsive to VR_{MAX}, VR_{MIN}, and Vknee@Ich_R. In some examples, the red channel feedback logic 544 determines feedback results as shown in Table 2.

TABLE 2
Red Channel Feedback Logic Operations

| Condition | Feedback Results | Feedback Value |
|---|---|---|
| V_{LEDR} - VR_{MAX} > | Decrease V_{LEDR} | V_{LEDR} - VR_{MAX} - |
| Vknee@Ich_R | | Vknee@Ich_R |
| Vknee@Ich_R > | Increase V_{LEDR} | Vknee@Ich_R - |
| V_{LEDR} - VR_{MAX} | | V_{LEDR+} VR_{MAX} |
| others | Maintain V_{LEDR} | null |

In some examples, the green channel feedback logic 546 operates to: receive VG_{MAX}, VG_{MIN}, Vknee for a predetermined green channel current (i.e., Vknee@Ich_G); and determine feedback results responsive to VG_{MAX}, VG_{MIN}, and Vknee@Ich_G. In some examples, the green channel feedback logic 546 determines feedback results as shown in Table 3.

TABLE 3
Green Channel Feedback Logic Operations

| Condition | Feedback Results | Feedback Value |
|---|---|---|
| V_{LEDG} - VG_{MAX} > | Decrease V_{LEDG} | V_{LEDG} - VG_{MAX} - |
| Vknee@Ich_G | | Vknee@Ich_G |
| Vknee@Ich_G > | Increase V_{LEDG} | Vknee@Ich_G - |
| V_{LEDG} - VG_{MAX} | | V_{LEDG+} VG_{MAX} |
| others | Maintain V_{LEDG} | null |

In some examples, the blue channel feedback logic 548 operates to: receive VB_{MAX}, VB_{MIN}, Vknee for a predetermined blue channel current (i.e., Vknee@Ich_B); and determine feedback results responsive to VB_{MAX}, VB_{MIN}, and Vknee@Ich_B. In some examples, the blue channel feedback logic 548 determines feedback results as shown in Table 4.

TABLE 4
Green Channel Feedback Logic Operations

| Condition | Feedback Results | Feedback Value |
|---|---|---|
| V_{LEDB} - VB_{MAX} > | Decrease V_{LED}B | V_{LEDB} - VB_{MAX} - |
| Vknee@Ich_B | | Vknee@Ich_B |
| Vknee@Ich_B > | Increase V_{LEDB} | Vknee@Ich_B - |
| V_{LEDB} - VB_{MAX} | | V_{LEDB+} VB_{MAX} |
| others | Maintain V_{LEDB} | null |

In some examples, the feedback results logic 550 stores the feedback results and the feedback value determined by each of the red channel feedback logic 544, the green channel feedback logic 546, and the blue channel feedback logic 548. The feedback results and the feedback value are provided to a controller (e.g., the controller 102 in FIG. 1) or a related processor (e.g., the processor 480 in FIG. 4).

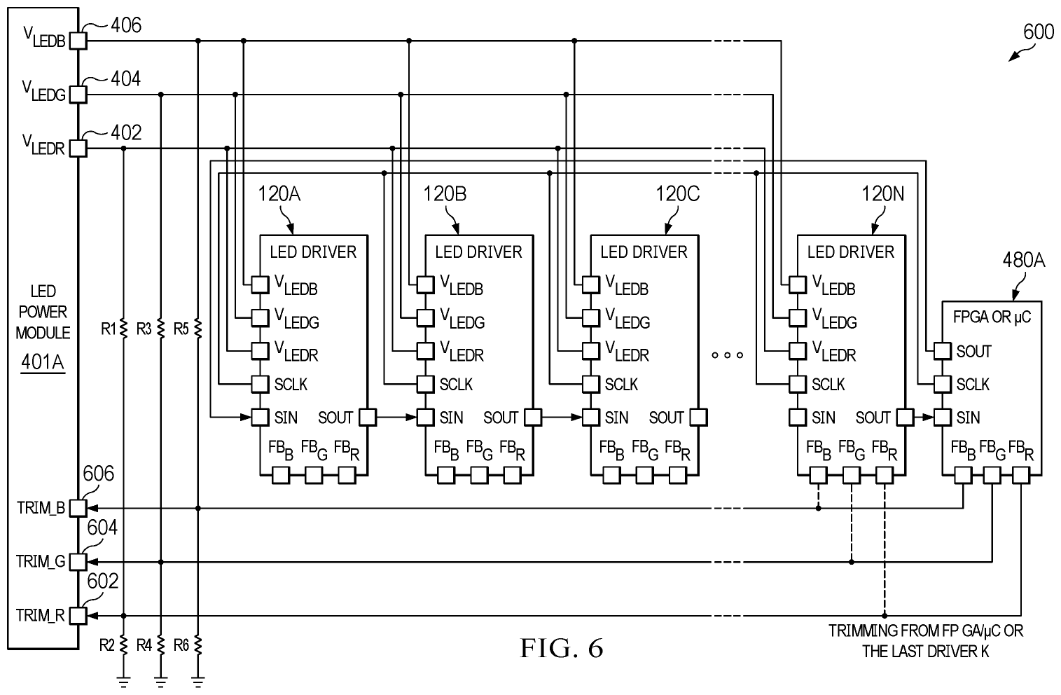

FIG. 6 is a block diagram showing other example display circuitry 600. In the example of FIG. 6, the display circuitry 600 includes an LED power module 401A, LED drivers 120A to 120N, a processor 480A, and resistors R1 to R6. The LED power module 401A is an example of the LED power module 401 in FIG. 4. The processor 480A is an example of the processor 480 in FIG. 4. In different examples, the processor 480A may be a field-programmable gate array (FPGA) or microprocessor.

As shown, the LED power module 401A has the first terminal 402, the second terminal 404, the third terminal 406, and fourth terminal 602, a fifth terminal 604, and a sixth terminal 606. Each of the fourth terminal 602, the fifth terminal 604, and the sixth terminal 606 is an example of the fourth terminal 407 in FIG. 4. Each of the LED drivers 120A to 120N has a V_{LEDB} terminal, V_{LEDG} terminal, V_{LEDG} terminal, an input clock (SCLK) terminal, an input data (SIN) terminal, an output data (SOUT) terminal, a blue feedback (FB_{B}) terminal, a green feedback (FB_{G}) terminal, and a red feedback (FB_{R}) terminal. The processor 480A has a SIN terminal, an SCLK terminal, an SOUT terminal, an FB_{B} terminal, an FB_{G} terminal, and an FB_{R} terminal. In the example of FIGS. 4, 5, and 6, SIN terminals, SCLK terminals, and SOUT terminals refer to serial peripheral interface (SPI) communication standard terminals. Other communication standards and related terminals are also possible. Each of the resistors R1 to R6 has a first terminal and a second terminal.

In the example of FIG. 6, respective V_{LEDR} terminals of the LED drivers 120A to 120N are coupled to the first terminal 402 of the LED power module 401A. Respective V_{LEDG} terminals of the LED drivers 120A to 120N are coupled to the second terminal 404 of the LED power module 401A. Respective V_{LEDB} terminals of the LED drivers 120A to 120N are coupled to the third terminal 406 of the LED power module 401A. The SIN terminal of the LED driver 120A is coupled to the SOUT terminal of the processor 480A. The SOUT terminal of the LED driver 120A is coupled to the SIN terminal of the LED driver 120B. Similarly, the SOUT terminal of the LED driver 120B is coupled to the SIN terminal of the LED driver 120C and so on up to the SOUT terminal of the LED driver 120N being coupled to the SIN terminal of the processor 480A. The SCLK terminals of the LED drivers 120A to 120N and of the processor are coupled to a clock generator or other clock source.

The first terminal of the resistor R1 is coupled to the first terminal 402 of the LED power module 401A. The second terminal of the resistor R1 is coupled to the fourth terminal 602 and to the first terminal of the resistor R2. The second terminal of the resistor R2 is coupled to ground or a ground terminal. The first terminal of the resistor R3 is coupled to the second terminal 404 of the LED power module 401A. The second terminal of the resistor R3 is coupled to the fifth terminal 604 and to the first terminal of the resistor R4. The second terminal of the resistor R4 is coupled to ground or a ground terminal. The first terminal of the resistor R5 is coupled to the third terminal 406 of the LED power module 401A. The second terminal of the resistor R5 is coupled to the sixth terminal 606 and to the first terminal of the resistor R6. The second terminal of the resistor R6 is coupled to ground or a ground terminal.

In the example of FIG. 6, the LED power module operates to: provide V_{LEDR} at the first terminal 402; provide V_{LEDG} at the second terminal 404; provide V_{LEDB} at the third terminal 406; receive a red trim control signal (TRIM_R) at the fourth terminal 602; receive a green trim control signal (TRIM_G) at the fifth terminal 604; receive a blue trim control signal (TRIM_B) at the sixth terminal 606; and update V_{LEDR}, V_{LEDG}, and V_{LEDB} as needed responsive to TRIM_R, TRIM_G, and TRIM_B.

Each of the LED drivers 120A to 120N operates to: receive control voltages (e.g., V_{LEDR}, V_{LEDG}, V_{LEDB}) at respective terminals; selectively provide currents to red LED channel terminals (e.g., the set of fourth terminals 414A to 414M in FIG. 4) responsive to V_{LEDR}; selectively provide currents to the green LED channel terminals (e.g., the set of fifth terminals 416A to 416M in FIG. 4) responsive to V_{LEDG}; and selectively provide currents to the blue LED channel terminals (e.g., the set of sixth terminals 418A to 418M in FIG. 4) responsive to V_{LEDB}. Each of the LED drivers 120A to 120N operates to: monitor red LED channel voltage levels (e.g., VR₀ to VR_{M}); monitor green LED channel voltage levels (e.g., VG₀ to VG_{M}); monitor blue LED channel voltage levels (e.g., VB₀ to V_{M}); determine FBR_R responsive to the monitored red LED channel voltage levels; determine FBR_G responsive to the monitored green LED channel voltage levels; and determine FBR_B responsive to the monitored blue LED channel voltage levels. In some examples, each of the LED drivers 120A to 120N of FIG. 6 may perform the example LED driver operations described in FIG. 1, FIG. 4, and/or FIG. 5.

In some examples, respective FBR_R values, respective FBR_G values, and respective FBR_B values from the LED drivers 120A to 120N are accumulated and provided to the processor 480A via the SPI interface and related terminals. To reduce the bandwidth needed to provide feedback results to the processor 480A, the LED drivers 120A to 120N may provide only a maximum FBR_R value, a maximum FBR_G value, and maximum FBR_B value to the processor 480A. In such examples, only the last LED driver (e.g., the LED driver 120N) is coupled to the processor 480A. Regardless of the particular communication technique used to provide feedback results to the processor 480A, the processor 480A may operate to: determine a red trim value (TRIM_R) responsive to the FBR_R values or a related maximum; determine a green trim value (TRIM_G) responsive to the FBR_G values or a related maximum; determine a blue trim value (TRIM_B) responsive to the FBR_B values or a related maximum; provide TRIM_R to the FB_{R} terminal of the processor 480A; provide TRIM_G to the FB_{G} terminal of the processor 480A; and provide TRIM_B to the FB_{B} terminal of the processor 480A. In some examples, TRIM_R, TRIM_G, TRIM_B are digital codes representing control voltage values. In other examples, TRIM_R, TRIM_G, TRIM_B are digital codes representing control voltage adjustment amounts. In either case, the LED power module 401A may convert TRIM_R, TRIM_G, TRIM_B to respective analog values and use the respective analog values to adjust V_{LEDR}, V_{LEDG}, and V_{LEDB} as needed. In the example of FIG. 6, the resistors R1 to R6 are direct-current to direct-current (DC/DC) feedback resistors to help set V_{LEDR}, V_{LEDG}, and V_{LEDB}.

In the example of FIG. 6, each of the LED drivers 120A to 120N may provide individual feedback results via respective SOUT terminals or via respective feedback terminals (e.g., a respective FB_{B} terminal, a respective FB_{G} terminal, and a respective FB_{R} terminal) to the processor 480A. As another option, LED drivers 120A to 120N may communicate with each other and provide cumulative feedback results via respective SOUT terminals or via respective feedback terminals to the processor 480A. The processor 480A may analyze the individual feedback results or the cumulative feedback results and provide trim control signals (e.g., TRIM_R, TRIM_G, TRIM_B) to the LED power module 401A. The LED power module 401A uses the trim control signals to adjust control voltages for the LED drivers 120A to 120N.

In other examples, the LED drivers 120A to 120M may provide individual feedback results via respective SOUT terminals or via respective feedback terminals to a last LED driver (e.g., the LED driver 120N) of the LED drivers 120A to 120N. As another option, LED drivers 120A to 120M may communicate with each other and provide cumulative feedback results via respective SOUT terminals or via respective feedback terminals to the LED driver 120N. In some examples, the LED driver 120N may use the individual feedback results or the cumulative feedback results to trim the LED control voltages without further signaling to the processor 480A and/or to the LED power module 401A.

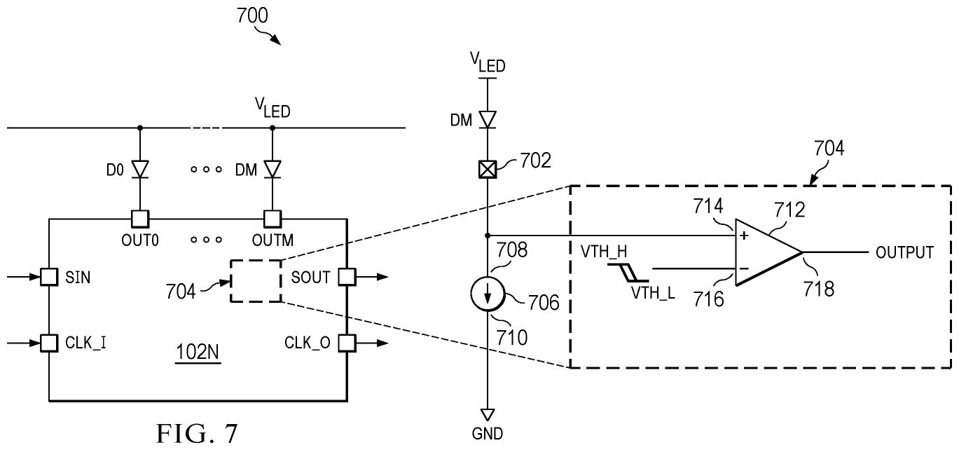

FIG. 7 is a diagram showing other example display circuitry 700. In the example of FIG. 7, the display circuitry 700 incudes the LED driver 120N and related LEDs DO to DM. The LED driver 120N includes a terminal 702, a current source 706, and channel comparator circuitry 704. For example, the terminal 702 may be one of terminals of the set of fourth terminals 414A to 414M in FIG. 4, one of terminals of the set of fifth terminals 416A to 416M in FIG. 4, or one of terminals of the set of sixth terminals 418A to 418M in FIG. 4. The current source 706 has a first terminal 708 and a second terminal 710. The first terminal 708 of the current source 706 is coupled to the terminal 702. The second terminal 710 of the current source 706 is coupled to ground or a ground terminal. As an example, the current source 706 may one of the current sources of the first set of current sources 462A to 462M in FIG. 4, one of the current sources of the second set of current sources 464A to 464M in FIG. 4, or one of the current sources of the third set of current sources 466A to 466M in FIG. 4.

As shown, the channel comparator circuitry 704 includes a comparator 712 having a first (e.g., non-inverting) terminal 714, a second (e.g., inverting) terminal 716, and a third terminal 718. The first terminal 714 of the comparator 712 is coupled to the terminal 702 and the first terminal 708 of the current source. The second terminal 716 of the comparator 712 is coupled to a reference voltage source (not shown) and receives a reference voltage VTH_L. In some examples, the third terminal 718 of the comparator 712 is coupled to an ADC for digitization, where digitized comparison results are provided to a digital core (e.g., the digital core 434 in FIG. 4, or the digital core 434A in FIG. 5).

In some examples, VTH_L sets a minimum operational voltage of constant current for the channel. A related reference voltage (VTH_H) sets a hysteresis range for feedback stability. The output of the comparator 712 is used as a feedback signal for the respective channel. In some examples, each channel supported by the LED driver 120N includes respective channel comparator circuitry. Also, each of multiple LED drivers (e.g., LED drivers 120A to 120N in FIGS. 1, 4, and 6 may include respective channel comparator circuitry for each respective channel. In some examples, the feedback signals from all channel comparator circuitry is merged into a feedback result. In some examples, if feedback signals vary, a prioritization scheme may be used. Table 5 shows example feedback control options.

TABLE 5

| Priority | Condition | Feedback result |
|---|---|---|
| 1 | Any comparator output < | Increase control voltage |
| | VTH_L | |
| 2 | Any comparator output > | Decrease control voltage |
| | VTH_H | |
| 3 | VTH_L < any comparator | Maintain control voltage |
| | output < VTH_H | |

With the feedback control option of Table 1, the feedback signals for each color are merged to determine whether an adjustment for each related control voltage (e.g., V_{LEDR}, V_{LEDG}, V_{LEDB}). In some examples, the amount of adjustment may be controlled based on increase voltage step values or decrease voltage step values stored in registers or other storage elements.

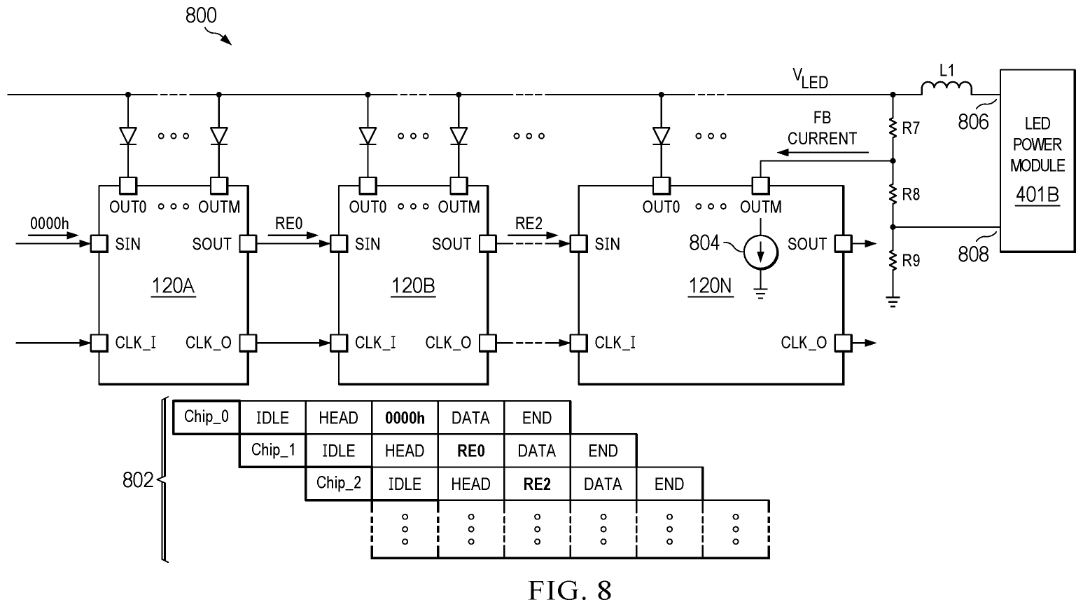

FIG. 8 is a diagram showing other example display circuitry 800. The display circuitry 800 includes the LED drivers 120A to 120N, respective LED diodes (not individually labeled), resistors R7 to R9, an inductor L1, and an LED power module 401B. The LED power module 401B is an example of the LED power module 401 in FIG. 1, and the LED power module 401A in FIG. 6. In the example of FIG. 8, each of the LED drivers 120A to 120N include output terminals (OUT0 to OUTM), a SIN terminal, a SOUT terminal, an input clock (CLK_I) terminal, and an output clock (CLK_O) terminal. Each of the resistors R7 to R9 has a first terminal and a second terminal. The inductor L1 has a first terminal and a second terminal. The LED power modulator 401B has a first terminal 806 and a second terminal 808.

In the example of FIG. 8, the first terminal of the LED power module 401B is coupled to the first terminal of the inductor L1. The second terminal of the inductor L1 is coupled to the first terminal of the resistor R7 and to respective anode terminals of the LED diodes controlled by for each of the LED drivers 120A to 120N. The cathode terminals of the LED diodes are coupled to respective output terminals of the LED drivers 120A to 120N. The second terminal of the resistor R7 is coupled to the OUTM terminal of the LED driver 120N and to the first terminal of the resistor R8. The second terminal of the resistor R8 is coupled to the second terminal 808 of the LED power module 401A and to the first terminal of the resistor R9. The second terminal of the resistor R9 is coupled to ground or a ground terminal.

In the example of FIG. 8, the SIN terminal of the LED driver 120A may be coupled to the SOUT terminal of a processor (e.g., as in FIG. 6). The SOUT terminal of the LED driver 120A is coupled to the SIN terminal of the LED driver 120B, and so on until the LED driver 120N. The CLK_I terminal of the LED driver 120A is coupled to a clock generator or other clock source (not shown). The CLK_O terminal of the LED driver 120A is coupled to the CLK_I terminal of the LED driver 120B, and so on until the LED driver 120N. In other words, the LED drivers 120A to 120N in FIG. 8 are part of a communication chain.

During current regulation and feedback control operations, the LED drivers 120A to 120N accumulate feedback results data 802. More specifically, the LED driver 120A provides Chip_0 feedback result data, the LED driver 120A provides Chip_1 feedback result data, and so on. In some examples, the feedback result data (sometimes referred to herein as cumulative feedback results) for each of the LED drivers 120A to 120N includes idle bits, header bits, feedback result bits, data bits, and end bits. In other examples, the communication protocol may vary.

In some examples, the last LED driver 120N receives the feedback result data 802 from all of the LED drivers 120A to 120N and is able to trim a control voltage (V_{LED}) responsive to the feedback result data 802. In some examples, the V_{LED} correspond to V_{LEDR}, V_{LEDG}, Or V_{LEDR} herein. In some examples, the LED driver 120N includes a current source 804. By adjusting the current through the current source 804 responsive to the feedback result data 802, the LED driver 120N operates to trim (e.g., increase, decrease, or maintain) V_{LED}. In some examples, the LED power module 401B is able to adjust trim operations by control of a feedback current (FB CURRENT), which is based on the current through the resistors R7 to R9 in FIG. 8.

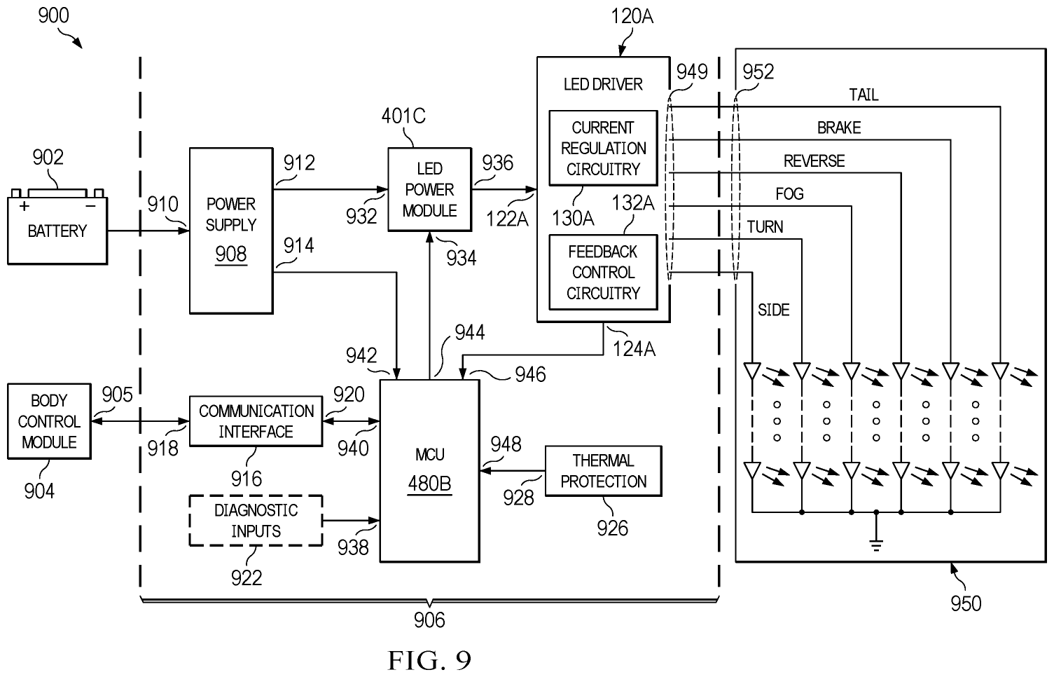

FIGS. 9-11 are diagrams showing example systems. In the example of FIG. 9, the system 900 may be a vehicle. As shown, the system 900 includes a battery 902, a body control module 904, a power supply 908, a communication interface 916, a processor 480B, an LED power module 401C, thermal protection circuitry 926, the LED driver 120A, and LED strings 950. The processor 480B is an example of the processor 480 in FIG. 4, or the processor 480A in FIG. 6. The LED power module 401C is an example of the LED power module 401 in FIG. 4, the LED power module 401A in FIG. 6, or the LED power module 401B in FIG. 8. In the example of FIG. 9, the power supply 908, the communication interface 916, the processor 480B, the LED power module 401C, the thermal protection circuitry 926, and the LED driver 120A are example components of display circuitry 906 of the system 900. In some examples, the LED driver 120A and the LED strings 950 are example components of an LED board or panel of the system 900.

The body control module 904 has a terminal 905. The power supply 908 has a first terminal 910, a second terminal 912, and a third terminal 914. The communication interface 916 has a first terminal 918 and a second terminal 920. The processor has a first terminal 938, a second terminal 940, a third terminal 942, a fourth terminal 944, a fifth terminal 946, and a sixth terminal 948. The LED power module has a first terminal 932, a second terminal 934, and a third terminal 936. The LED driver 120A has the first terminal 122A, the second terminal 124A, and a set of terminal 949. The LED strings 950 has a set of terminals 952.

The first terminal 910 of the power supply 908 is coupled to the battery 902 and receive a positive voltage. The second terminal 912 of the power supply 908 is coupled to the first terminal 932 of the LED power module 401C. The third terminal 914 of the power supply 908 is coupled to the third terminal 942 of the processor 480B. The second terminal 934 of the LED power module 401C is coupled to the fourth terminal 944 of the processor 480B. The third terminal 936 of the LED power module 401C is coupled to the first terminal 122A of the LED driver 120A. In the example of FIG. 9, the LED driver 120A includes the current regulation circuitry 130A and the feedback control circuitry 132A described previously. The second terminal 124A of the LED driver 120A is coupled to the fifth terminal 946 of the processor 480B. The set of terminals 949 of the LED driver 120A is coupled to the set of terminals 952 of the LED strings 950. In the example of FIG. 9, the LED strings 950 includes example LED channels for side LED lights, turn signal LED lights, fog LED lights, reverse LED lights, brake LED lights, and tail LED lights. The sixth terminal 948 of the processor 480B is coupled to the terminal 928 of the thermal protection circuitry 926. The first terminal of the 938 of the processor 480B is coupled to diagnostic circuitry (not shown) and receives diagnostic inputs 922. The terminal 905 of the body control module 904 is coupled to the first terminal 918 of the communication interface 916. The second terminal 920 of the communication interface 916 is coupled to the second terminal 940 of the processor 480B.

The battery 902 operates to provide voltage and current to the power supply 908. The power supply 908 operates to: receive voltage and current from the battery 902; and provide regulated power to the LED power module 401C and the processor 480B. The LED power module 401C operates to provide control voltages to the LED driver 120A responsive to trim control signals from the processor 480B. The LED driver 120A operates to: selectively provide current to the set of terminals 952 of the LED strings 950 responsive to control voltages provided by the LED power module 401C; monitor channel voltages of the LED strings 950; and provide feedback results at the second terminal 124A responsive to the monitored channel voltages.

The body control module 904 operates to update the display. The communication interface 916 operates to convey display information between the terminal 905 of the body control module 904 and the second terminal 940 of the processor 480B. In some examples, the first terminal 938 of the processor 480B receives diagnostic inputs. The thermal protection circuitry 926 operates to: detect an overtemperature condition; and selectively provide an overtemperature indicator at the terminal 928 responsive to the overtemperature condition. The processor 480B operates to: receive diagnostic inputs at the first terminal 938; receive updated information at the second terminal 940; receive regulated power at the third terminal 942; receive feedback results at the fifth terminal; selectively receive an overtemperature indicator at the sixth terminal 948; and provide trim control signals at the fourth terminal 944 responsive to the feedback results. In some examples, the processor 480B also operates to enter a failsafe mode responsive to the diagnostic inputs; provide diagnostic results to the body control module 904. In response to an overtemperature indicator, the processor 480B may shut down or reduce operations of the system 900.

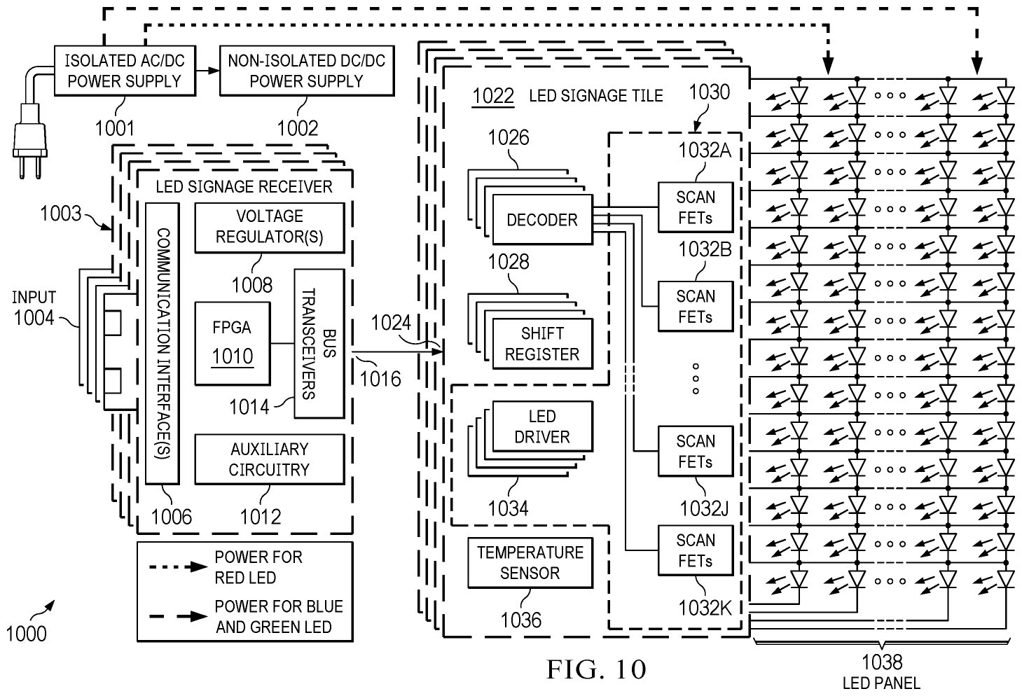

In the example of FIG. 10, the system 1000 is an LED signage system. As shown, the system 1000 includes isolated alternating-current/direct-current (AC/DC) power supply circuitry 1001, non-isolated DC/DC power supply circuitry 1002, LED signage receiver circuitry 1003, LED signage tile circuitry 1022, and LED panel circuitry 1038.

In some examples, the isolated AC/DC power supply circuitry 1001 includes a flyback controller and a synchronous rectifier. The non-isolated DC/DC power supply circuitry 1002 may include buck converter circuitry, load switch circuitry, low-dropout regulator (LDO) circuitry, multi-channel circuitry, and/or voltage reference circuitry. The LED signage receiver circuitry 1003 of the LED signage receiver circuitry 1003 may include multiple LED signage receivers. In some examples, each LED signage receiver of the LED signage receiver circuitry 1003 may include an input 1004, communication interface(s) circuitry 1006, voltage regulator(s) circuitry 1008, an FPGA 1010, auxiliary circuitry 1012, bus transceivers 1014, and a terminal 1016. In some examples, the communication interface(s) circuitry 1006 may include an HDBaseT receiver, an Ethernet physical layer, and/or a Recommended Standard 232 (RS-232) interface. In some examples, voltage regulator(s) circuitry 1008 may include buck converter circuitry and/or LDO circuitry. In some examples, the auxiliary circuitry 1012 may include a processor, a clock generator, a temperature sensor, low-voltage differential signaling (LVDS) circuitry, hot swap circuitry, and/or monitoring circuitry.

In the example of FIG. 10, the LED signage tile circuitry 1022 includes multiple LED signage tiles. Each of the LED signage tiles of the LED signage tile circuitry 1022 includes a terminal 1024, decoders 1026, shift registers 1028, display circuitry 1030, and a temperature sensor 1036. In some examples, the display circuitry 1030 includes LED drivers 1034, and sets of scan field-effect transistors (FETs) 1032A to 1032K. The LED panel circuitry 1038 includes channels of LEDs (e.g., red LED, green LEDs, and blue LEDs), where voltages and currents for each channel of LEDs of the LED panel circuitry 1038 is controlled by the LED signage tile circuitry 1022. In some examples, the LED drivers 1034 perform the same or similar operations as the LED drivers 120A to 120N described previously. Such operations include the current regulation operations and the feedback control operations described herein.

In the example of FIG. 10, power for system 1000 is regulated using the isolated AC/DC power supply circuitry 1001 and the non-isolated DC/DC power supply circuitry 1002. The LED signage receiver circuitry 1003 operates to: receive display information via each input 1004; and provide decoded and converted LED control data at the terminal 1016 responsive to processing operations of the FPGA 1010. In some examples, the FPGA 1010 operates to decode and convert input signals to an LED driver protocol.

The LED signage tile circuitry 1022 operates to: receive LED driver protocol data from the LED signage receiver circuitry 1003; and provide data/control signals to the LED panel circuitry 1038 responsive to the LED driver protocol data and operations of the decoders 1026, the shift registers 1028, and the display circuitry 1030. In some examples, the decoders 1026 operate to convert input commands to control signals for the scan FETs 1032A to 1032K. The shift registers 1028 operate to: receive input commands from the terminal 1024; and provide the input commands to the decoders 1026 in sequence. The temperature sensor 1036 operates to: determine if the temperature of an LED driver is above a threshold; and provide a control signal to initiate thermal shut down responsive to detecting that the temperature of the LED driver is above the threshold.

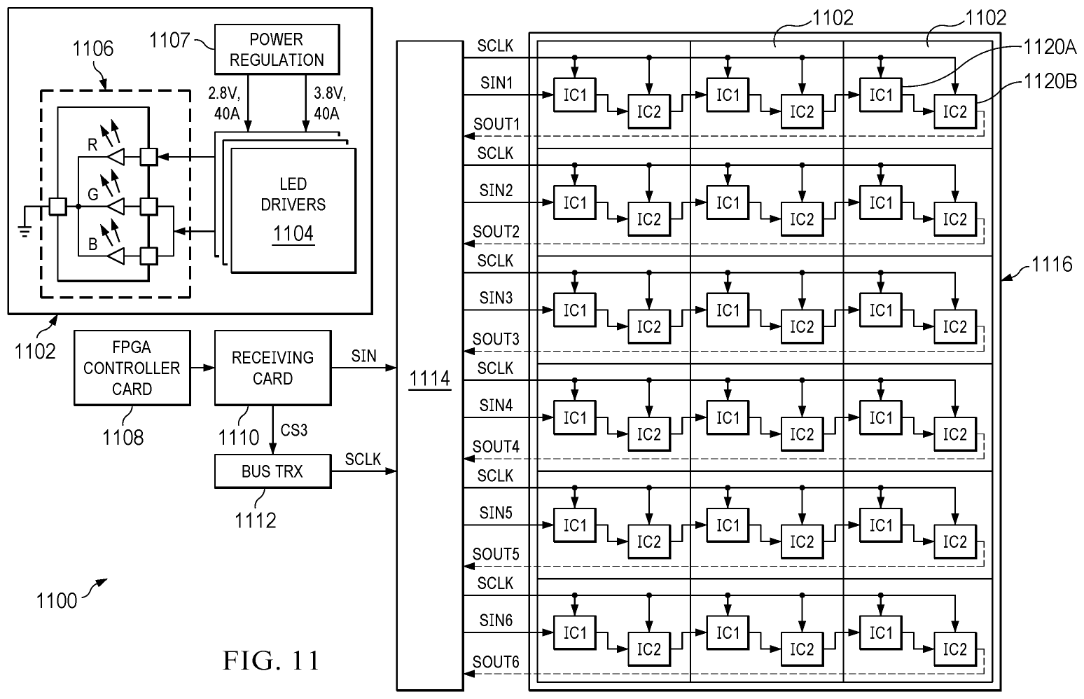

In the example of FIG. 11, the system 1100 is a display. As shown, the system 1100 includes an FPGA controller card 1108, a receiving card 1110, a bus transceiver 1112, a hub 1114, and an array 1116 of LED panels 1102. Each of the LED panels 1102 includes LED drivers 1104, LED strings 1106, and power regulation circuitry 1107. In some examples, the power regulation circuitry 1107 includes power factor correction circuitry, a resonant circuit (e.g., LLC circuitry), buck converter circuitry, and/or other circuitry.

In some examples, each of the LED panels 1102 of the array 1116 includes two integrated circuits (ICs) 1120A and 1120B. Each of the ICs 1120A and 1120B includes LED drivers 1104 and power regulation circuitry 1107. Without limitation, each LED panel 1102 may include two ICs that provide a total of 36 LED drivers and may support a 32×18 RGB LED array. In some examples, a 4K screen may use 28,800 LED drivers and related ICs. In some examples, the LED drivers 1104 may perform current regulation operations and feedback control operations as described previously for the LED drivers 120A to 120N.

In the example of FIG. 11, the FPGA controller card 1108 operates to provide the latest display information. The receiving card 1110 operates to: receive the display information; and assign FPGA outputs to different buses (SINx) via the hub 1114 for use by the array 1116. In some examples, the receiving card 1110 transmits the data/control signals to the hub 1114 using SPI communications. In some examples, the bus transceiver 1112 operates to: receive control signals (CS3) from the receiving card 1110; and provide a clock signal to the hub 1114 responsive to CS3.

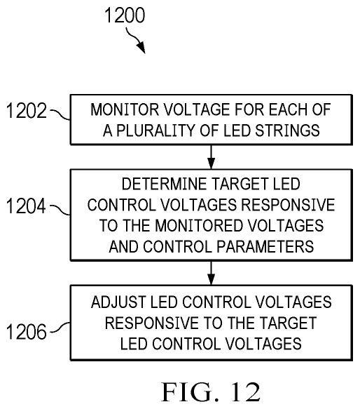

FIG. 12 is a flowchart showing an example LED driver control method 1200. The LED driver control method 1200 may be performed by any LED driver of the LED drivers described in FIGS. 1, 4, 6, 8, 9, 10, and 11. As shown, the LED driver control method 1200 include monitoring voltage for each of a plurality of LED strings (or LED channels) at block 1202. At block 1204, target LED control voltages are determined responsive to the monitored voltages and control parameters (e.g., a current control voltage, a global brightness setting, individual color brightness settings, Vknee for each channel, a maximum voltage for each channel color, a minimum voltage for each channel color). At block 1206, LED control voltages are adjusted responsive to the target LED control voltages. In some examples, the LED driver control method 1200 performs the current regulation operations and the feedback control operations described herein.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated circuit. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described examples, and other examples are possible, within the scope of the claims.

1. A light-emitting diode (LED) driver comprising:
current regulation circuitry;
feedback control circuitry coupled to the current regulation circuitry; and
a set of terminals coupled to the current regulation circuitry and adapted to be coupled to respective LED strings, wherein the current regulation circuitry is configured to selectively provide current to each of the LED strings, and the feedback control circuitry is configured to:
monitor a voltage level for each of the LED strings while current is being provided; and
provide feedback results responsive to the monitored voltage levels.

2. The LED driver of claim 1, wherein the feedback control circuitry includes analog-to-digital converters (ADCs) and a processor, the ADCs are configured to convert the monitored voltage levels to digital signals, and the processor is configured to:
receive the digital signals; and
determine the feedback results responsive to the monitored voltage levels.

3. The LED driver of claim 1, wherein the feedback control circuitry is configured to:
determine a maximum voltage level for each of a plurality of LED string colors of the LED strings responsive to the monitored voltage levels; and
provide the feedback results responsive to the maximum voltage levels.

4. The LED driver of claim 1, wherein the feedback control circuitry is configured to:
obtain a target voltage for a given LED string of the LED strings;
compare the monitored voltage level of the given LED string with the target voltage to obtain comparison results; and
provide the feedback results responsive to the comparison results, wherein the feedback results are used to increase a control voltage for the given LED string if the monitored voltage level is less than the target voltage by more than a threshold amount.

5. The LED driver of claim 1, wherein the feedback control circuitry is configured to:
obtain a target voltage for a given LED string of the LED strings;
compare the monitored voltage level of the given LED string with the target voltage to obtain comparison results; and
provide the feedback results responsive to the comparison results, wherein the feedback results are used to decrease a control voltage for the given LED string if the monitored voltage level is greater than the target voltage by more than a threshold amount.

6. The LED driver of claim 1, wherein the feedback control circuitry is configured to:
obtain a target voltage for a given LED string of the LED strings;
compare the monitored voltage level of the given LED string with the target voltage to obtain comparison results; and
provide the feedback results responsive to the comparison results, wherein the feedback results are used to maintain a control voltage for the given LED string if the monitored voltage level does not differ from the target voltage by more than a threshold amount.

7. The LED driver of claim 1, wherein the feedback control circuitry is configured to:
calculate an output current for a given LED string of the LED strings based on a global brightness control signal and a color brightness control signal;
use the calculated output current to determine a knee voltage for the given LED string;
determine a target voltage for the given LED string based on the knee voltage;
compare the monitored voltage level of the given LED string with the target voltage to obtain comparison results; and
provide the feedback results responsive to the comparison results.

8. The LED driver of claim 7, wherein the feedback control circuitry is configured to:
store a look-up table (LUT) that includes knee voltages as a function of output current; and
determine the knee voltage for the given LED string by using the calculated output current to look up a respective knee voltage in the LUT.

9. A circuit comprising:
a controller having a first terminal and a second terminal; and
a light-emitting diode (LED) driver having a first terminal, a second terminal, and output terminals, the first terminal of the LED driver coupled to first terminal of the controller, the second terminal of the LED driver coupled to the second terminal of the controller, the output terminals adapted to be coupled to respective LED strings,
wherein the controller is configured to:
provide a light-emitting diode (LED) control voltage at its first terminal;
receive feedback results at its second terminal; and
selectively adjust the LED control voltage provided to the first terminal responsive to the feedback results, and
wherein the LED driver is configured to:
receive the LED control voltage at its first terminal;
selectively provide a current to each of the LED strings, the current for at least some of the LED strings based on the LED control voltage;
monitor a voltage level for each of the LED strings while current is being provided; and
provide the feedback results at its second terminal responsive to the monitored voltage levels.

10. The circuit of claim 9, wherein the controller includes a processor and an LED power module, the LED driver includes analog-to-digital converters (ADCs), the feedback results include a digital signal, the processor is configured to provide a trim control signal to the LED power module responsive to the digital signal, and the LED power module is configured to adjust the LED control voltage responsive to the trim control signal.

11. The circuit of claim 9, wherein the LED control voltage is a first LED control voltage, the controller includes a third terminal, the controller is configured to:
provide a second LED control voltage at the third terminal of the controller;
selectively adjust the first LED control voltage provided to the first terminal of the controller responsive to the feedback results; and
selectively adjust the second LED control voltage provided to the third terminal of the controller responsive to the feedback results.

12. The circuit of claim 11, wherein the LED driver is configured to:
receive the first LED control voltage at its first terminal;
receive the second LED control voltage at its third terminal;
selectively provide a current to each of the LED strings, the currents for a first set of the LED strings based on the first LED control voltage, and the currents for a second set of the LED strings based on the second LED control voltage;
monitor a voltage level for each of the LED strings while current is being provided; and
provide the feedback results at its second terminal responsive to the monitored voltage levels.

13. The circuit of claim 9, further comprising additional LED drivers coupled to the controller, wherein the controller is configured to:
receive cumulative feedback results from the LED driver and each of the additional LED drivers; and
adjust an LED control voltage provided to each of the additional LED drivers responsive to responsive to the cumulative feedback results, the cumulative feedback results indicating an increase request, a decrease request, or a maintain request for each of multiple LED control voltages provided by the controller.

14. The circuit of claim 13, wherein the LED driver and the additional LED drivers are part of a communication chain, and a last LED driver of the communication chain is configured to provide the cumulative feedback results to the controller.

15. The circuit of claim 13, wherein the LED driver and the additional LED drivers are part of a communication chain, a last LED driver of the communication chain including a current source and configured to control the current source responsive to the cumulative feedback results to trim the LED control voltage.

16. The circuit of claim 9, wherein the LED driver includes respective comparators coupled to each of the output terminals, wherein the feedback results are based on outputs of the comparators.

17. A display comprising:
a controller;
light-emitting diode (LED) drivers coupled to the controller;
LED strings coupled to each of the LED drivers, wherein the controller is configured to:
receive feedback results from the LED drivers; and
dynamically adjust LED control voltages provided to the LED drivers responsive to the feedback results.

18. The display of claim 17, wherein each of the LED drivers is configured to:
monitor voltage levels for respective LED strings;
compare the monitored voltage levels with target voltages to obtain comparison results; and
provide the feedback results responsive to the comparison results.

19. The display of claim 17, wherein each of the LED drivers is configured to:
calculate an output current for a given LED string of the LED strings based on a global brightness control signal and a color brightness control signal;
use the calculated output current to determine a knee voltage for the given LED string;
determine a target voltage for the LED string based on the knee voltage;
compare a monitored voltage level of the given LED string with the target voltage to obtain comparison results; and
provide the feedback results responsive to the comparison results.

20. The display of claim 19, wherein each of the LED driver is configured to:
store a look-up table (LUT) that includes knee voltages as a function of output current; and
determine the knee voltage for the given LED string by using the calculated output current to look up a respective knee voltage in the LUT.
